(19) United States
(12) Patent Application Publication
(10) Pub. No.: US 2022/0041891 A1
(43) Pub. Date: Feb. 10, 2022

(54) COATED PANELS PROVIDED VIA CURED POWDER, AND ASSOCIATED METHODS AND PRODUCTION APPARATUS

(71) Applicant: KEYLAND POLYMER MATERIAL SCIENCES, LLC, Cleveland, OH (US)

(72) Inventors: Michael F. Knoblauch, Cleveland Heights, OH (US); Evan H. Knoblauch, Cleveland, OH (US); Francis Popiel, Columbia Station, OH (US); Christoph Jocham, Linz (AT)

(21) Appl. No.: 17/394,890

(22) Filed: Aug. 5, 2021

Related U.S. Application Data
(60) Provisional application No. 63/061,296, filed on Aug. 5, 2020.

(51) Int. Cl. C09D 201/00; C08F 2/50

(52) U.S. Cl. CPC C09D 201/00; C08F 2/50

(57) ABSTRACT

A flat panel that includes a substrate that has at least one planar extent with a surface contour thereon, and a cured-on-substrate photopolymer upon the planar extend of the substrate. The photopolymer extends into the surface contour of the planar extend of the substrate from application of a melting force to an initial powder form of the photopolymer. The photopolymer is solidified into a cured unitary mass from application of curing irradiation. A method of providing a flat panel. An apparatus makes the flat panel.

### RELATED APPLICATION

Benefit of priority is claimed from U.S. Provisional Application No. 63/061,296 filed Aug. 5, 2020, and the entire disclosure of which is incorporated herein by reference.

### FIELD

The present disclosure relates generally to finished panels, and associated methods and production apparatus, in which a cured powder is used for coating provision.

### BACKGROUND

Finished, flat panels contain at least one side that contains a decorative, protective, and/or color finish. Such finished panels are typically used as components in the production/construction of other, more complete items, such as buildings, furniture, etc.

Typically, such decorative, protective, and/or color finish is provided via lamination of a decorative, protective, and/or color finish layer onto a substrate, paint or stain application onto a substrate, or a similar process. Although such production techniques remain viable, it is to be recognized that such surface application techniques may have issues. For example, delamination may occur. Also, surface adhesion may be below expectation. Also, time required to manufacture should be considered.

For currently available techniques that utilize a thermal-melt powder that is heated and pressed for panel lamination, the laminate is applied and held under pressure in a press for a sufficient time for the thermal melting, cooling and, thus, adhesion to occur. As an example of a held-in press time can be 1-10 minutes. As such, use of a platen press, e.g., a single panel press, is logical because a continuously moving arrangement (e.g., a conveyor with a pressure maintained for the entire adhesion process) would need to be very large. For example, to use conveyor process with a thermal cured powder would require an extraordinarily long conveyor system. Assuming a line speed of 100 feet/minute (approx. 91 meters/minute) and a melt to cure time of 3 minutes, the conveyor length would need to be 300 feet (approx. 91 meters) for just the pressing time and the pressing would need to occur for the 300 feet (approx. 91 meters) length.

### BRIEF EXAMPLE SUMMARY

The following presents a simplified example summary in order to provide a basic understanding of some aspects of the present disclosure. This summary is not an extensive overview of the present disclosure. It is intended to neither identify key or critical elements nor delineate the scope of the present disclosure. Its sole purpose is to present some concepts of the present disclosure in a simplified form as a prelude to the more detailed description that is presented later.

In accordance with an aspect, the present disclosure provides a flat panel that includes a substrate that has at least one planar extent with a surface contour thereon, and a cured-on-substrate photopolymer upon the planar extend of the substrate. The photopolymer extends into the surface contour of the planar extend of the substrate from application of a melting force to an initial powder form of the photopolymer. The photopolymer is solidified into a cured unitary mass from application of curing irradiation.

In accordance with an aspect, the present disclosure provides a method of providing a flat panel. The method includes providing a substrate having at least one planar extent with a surface contour thereon. The method includes providing an initial powder form of a photopolymer upon the planar extend of the substrate. The method includes applying melting force to the initial powder form of the photopolymer. The applied melting force causes the photopolymer to extend into the surface contour of the planar extend of the substrate. The method includes applying curing irradiation to solidify the photopolymer into a cured unitary mass. Application of a melting force is what transpires in the process interval between the deposition of the photopolymer on the substrate and the start of cure irradiation. Melting force can be 1.) the application of thermal energy that melts the photopolymer and ambient atmosphic pressure presses the photopolymer to the substrate, 2.) the application of thermal energy that melts the photopolymer followed by static pressing or roller pressing of the photopolymer to the substrate, 3.) a thermally heated static press or roller press(s) melts and presses the photopolymer to the substrate in any combination of 1, 2, or 3 or order sequence of application of thermal energy and static or roller pressing.

In accordance with an aspect, the present disclosure provides an apparatus for making a flat panel. The panel has a substrate with at least one planar extent with a surface contour thereon and a cured-on-substrate photopolymer upon the planar extend of the substrate. The photopolymer extends into the surface contour of the planar extend of the substrate from application of melting force to an initial powder form of the photopolymer. The photopolymer is solidified into a cured unitary mass from application of curing irradiation. The apparatus includes an arrangement for receiving the substrate. The apparatus includes an arrangement for applying the initial powder form of the photopolymer onto the planar extend of the substrate. The apparatus includes an arrangement for applying the melting force. The apparatus includes an arrangement for applying the curing irradiation to the photopolymer.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1A is a perspective view of an example flat panel including a cured-on photopolymer upon a substrate in accordance with the present disclosure.

FIG. 1B is an enlarged perspective view of the example flat panel of FIG. 1A, and shows the cured-on photopolymer being clear to permit visibility of the substrate.

FIG. 2A is a perspective view of another example flat panel including a cured-on photopolymer upon a substrate in accordance with the present disclosure, and shows the cured-on photopolymer being opaque but with layering of the cured-on photopolymer upon the substrate being readily visible at the edge.

FIG. 2B is an enlarged perspective view of the example flat panel of FIG. 2A.

FIG. 3A is a perspective view of another example flat panel including a cured-on photopolymer upon a substrate in accordance with the present disclosure, and shows the cured-on photopolymer being opaque but with layering of the cured-on photopolymer upon the substrate being readily visible at the edge.

FIG. 3B is an enlarged perspective view of the example flat panel of FIG. 2A.

FIG. 4A is a perspective view of another example flat panel including a cured-on photopolymer upon a substrate in accordance with the present disclosure, and shows the cured-on photopolymer being opaque but with layering of the cured-on photopolymer upon the substrate being readily visible at the edge.

FIG. 4B is an enlarged perspective view of the example flat panel of FIG. 2A.

FIG. 5 is a flowchart for an example method of providing a flat panel in accordance with the present disclosure.

FIG. 6 is a schematic illustration of an example apparatus for providing a flat panel in accordance with the present disclosure.

FIG. 7 is a schematic illustration of another apparatus for providing a flat panel in accordance with the present disclosure.

FIG. 8 is a schematic illustration of another apparatus for providing a flat panel in accordance with the present disclosure.

FIG. 9 is a schematic illustration of another apparatus for providing a flat panel in accordance with the present disclosure.

FIG. 10 is schematic illustration of another apparatus for providing a flat panel in accordance with the present disclosure.

### DETAILED DESCRIPTION

Subject matter will now be described more fully hereinafter with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted, or may be handled in summary fashion.

Certain terminology is used herein for convenience only and is not to be taken as a limitation on the disclosed subject matter. Relative language used herein is best understood with reference to the drawings, in which like numerals are used to identify like or similar items. Further, in the drawings, certain features may be shown in somewhat schematic form.

The following subject matter may be embodied in a variety of different forms, such as methods, devices, components, and/or systems. Accordingly, this subject matter is not intended to be construed as limited to any illustrative embodiments set forth herein as examples. Rather, the embodiments are provided herein merely to be illustrative.

Provided herein are examples of coated flat panels provided via cured powder, and associated methods and production equipment. Such can include powder coating paint, melting, and pressing onto a flat panel for protective and or decorative finishing. Also provided herein are examples of a method of providing a flat panel. Further provided herein are examples of an apparatus for making a flat panel.

As an example of an aspect of the disclosure regarding a flat panel, the panel includes a substrate that has at least one planar extent with a surface contour thereon, and a cured-on-substrate photopolymer upon the planar extend of the substrate. The photopolymer extends into the surface contour of the planar extend of the substrate from application of a melting force to an initial powder form of the photopolymer. The photopolymer is solidified into a cured unitary mass from application of curing irradiation.

As an example of an aspect of the disclosure regarding a method of providing a flat panel. The method includes providing a substrate having at least one planar extent with a surface contour thereon. The method includes providing an initial powder form of a photopolymer upon the planar extend of the substrate. The method includes applying melting force to the initial powder form of the photopolymer. The applied melting force causes the photopolymer to extend into the surface contour of the planar extend of the substrate. The method includes applying curing irradiation to solidify the photopolymer into a cured unitary mass.

As an example of an aspect of the disclosure regarding an apparatus for making a flat panel. The panel has a substrate with at least one planar extent with a surface contour thereon and a cured-on-substrate photopolymer upon the planar extend of the substrate. The photopolymer extends into the surface contour of the planar extend of the substrate from application of melting force to an initial powder form of the photopolymer. The photopolymer is solidified into a cured unitary mass from application of curing irradiation. The apparatus includes an arrangement for receiving the substrate. The apparatus includes an arrangement for applying the initial powder form of the photopolymer onto the planar extend of the substrate. The apparatus includes an arrangement for applying the melting force. The apparatus includes an arrangement for applying the curing irradiation to the photopolymer.

Some definitions may be useful for further discussion within this present disclosure.

Powder photopolymer coating paint—A solid state of matter material in a powder form 5-90 μm particle size. As an example, a particle size of approximately 27 μm may be used. The powder coating is melted and then cured using ultraviolet energy, electron beam or other energy sources. Curing method is a function of the specific chemical formulation of the powder coating of paint. The photopolymer may or may not contain a reactive photoinitiator. The presence of a photoinitiator is determined by the curing irradiation method. A photopolymer cure irradiated by electron beam does not require a photoinitiator to cure.

Melting—The powder coating without regard to curing method is melted to bring the solid powder to a liquid or gelled state. Melting can be by infrared (IR), gas catalytic, near IR (NIR), induction, convection used alone or in combination of any type.

Pressure—Pressure is applied to the surface of the powder coated panel following melting of the powder coating. The pressure smooths the coating, enhances the adhesion of the melted powder to the surface face of the coating. Static press or continuous roller can be used to apply pressure onto the coating surface. The static press platen and the roller may or may not be coated with a release material, embossing pattern or heated.

Photopolymer—Photopolymer is a polymer that changes its properties when exposed to a curing irradiation, such curing irradiation may include Ultra Violet (UV) light exposure, Electron Beam (EB) exposure, visible region of the electromagnetic spectrum exposure or the like. A photopolymer only cures when exposed to UV, EB or other high energy light source. The energy sources causes free radical polymerization or crosslinking of the metharcalated double bonds present unsaturated photopolymer resin. Presence of only a thermal energy source will not cure a photopolymer.

Cure—Cure is the measure of the crosslinked oligomer chains or fully reacted double bonds residing in the photopolymer coating matrix following exposure to the curing system, which can be Ultra Violet (UV) light exposure, Electron Beam (EB) exposure, or another high energy source. Within an example, the photopolymer may be provided as an unsaturated resin and a photoinitiator. The curing irradiation is then applied and the irradiation causes resin crosslinks as an example of curing.

Thermal curing may be a continuous process beginning with melting the powder coating followed by thermal ramp up to a temperature catalyzing and crosslinking the oligomer chains. Types of thermal energy used to cure a non-photopolymer material, electric IR, gas catalytic IR, NIR, induction, convection or a combination of these.

Ultra-Violet (UV) curing is a method where a chemical photoinitiator in the powder coating instantly responds to UV light energy initiating a chain crosslinking reaction and curing the coating. This is also known as photopolymerization. The melt stage is separate from the curing of the coating. Types of UV lights—medium pressure mercury lamps, pulsed xenon lamps, LEDs or lasers.

Electron Beam (EB) is a method where a stream of electrons is used irradiate the photopolymer crosslinking the double bonds in the compositional matrix and curing the photopolymer powder coating.

Panel—Application on wood panels maybe plywood, oriented strand board (OSB), particle board (PB), medium density fiber board (MDF), wood veneer panels or any other flat wood or wood product composite panel or similar that is finished in a two-dimensional horizontal application. Other materials such as fiberglass reinforced panels (FRP), carbon fiber, composite, plastic, sheet molded compound (SMC), bulk molded compound (BMC), metal ferrous or non-ferrous metal) or others can be coated.

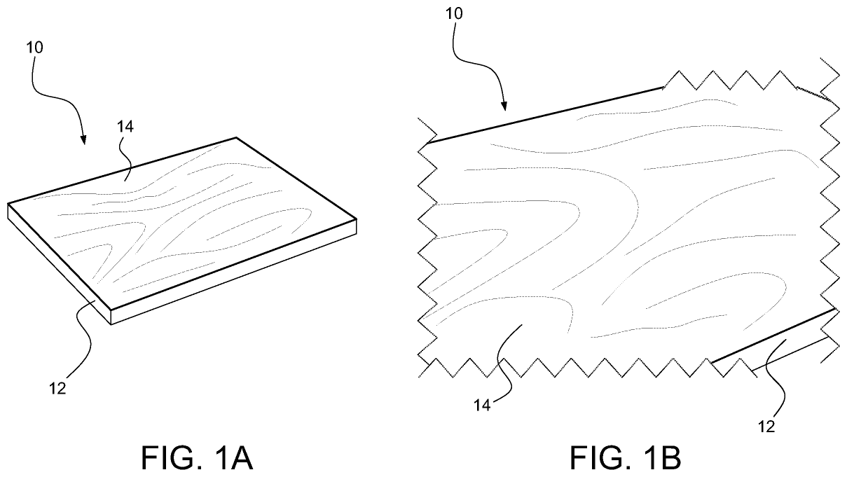

FIGS. 1A and 1B, 2A and 2B, 3A and 3B, and 4A and 4B show some examples of flat panels in accordance with the present disclosure. It is to be appreciated that these examples are only a sampling of possible constructions/configurations. It is to be appreciated that such sampling of examples need not be a limitation upon the present disclosure.

Within FIGS. 1A and 1B, an example flat panel 10 includes a substrate 12 and a cured-on-substrate photopolymer 14 thereon. Within the example, the substrate 12 is oriented strand board (OSB) with a thickness of 15 mm. As can be appreciated, the OSB substrate 10 has a planar extent and a surface contour thereon. Typically, the surface of OSB is considered generally smooth, but not completely smooth. The cured-on-substrate photopolymer 14 is provided from a powder that is ZTI9M13R2, smooth clear with filler, and is applied at a rate of 219 g/m². Within the example, the photopolymer 14 is generally clear, which allows the substrate to be visible therethrough. Melting is accomplished via hotpressing, and specifically at a temperature of 120° C. for 30 seconds. Pressure from the hotpressing is 100 N/cm². Such melting and/or pressure causes the photopolymer to extend into the surface contour of the planar extend of the substrate. A release paper is used in conjunction with the use of the hotpressing. A short time period (e.g., 30 seconds) was permitted after the hotpressing. Subsequent to the short time period, the release paper is removed. Thereafter, the photopolymer 14 is cured in place (i.e., in situ) with ultraviolet (UV) light irradiation. The time of UV light irradiation is a few seconds.

The result provides an outer surface, which is located away from the substrate 12, defined by the pressure force application. The photopolymer 14 is solidified into a cured unitary mass from application of curing irradiation. The photopolymer thickness is 115 μm. A good adhesion between the photopolymer and the substrate is present. Also, the photopolymer has good methyl ethyl ketone (MEK) resistance. A smooth outer surface can be achieved (e.g., if the hotpressing surface is itself smooth).

To be sure, the outer surface of the photopolymer 14 may have a texture that is different from the texture of the substrate 12. An example is that the outer surface of photopolymer 14 is smoother than the substrate 12. Another example is that the outer surface of photopolymer 14 has a texturing, contour, pattern or the like that is completely different from the substrate 12. Such difference in texture between substrate and outer surface of photopolymer 14 is possible for all examples discussed herein.

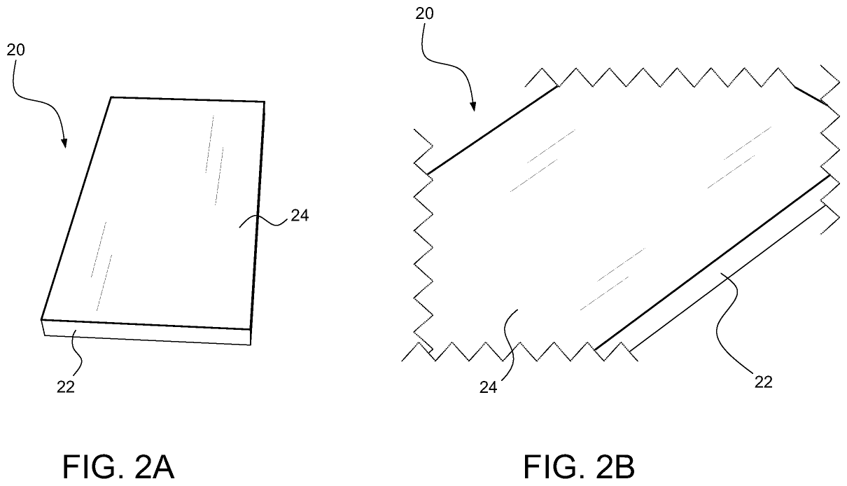

Within FIGS. 2A and 2B, an example flat panel 20 includes a substrate 22 and a cured-on-substrate photopolymer 24 thereon. Within the example, the substrate 22 is substrate therein is medium density fiberboard (MDF) with a thickness of 19 mm. As can be appreciated, the MDF substrate 22 has a planar extent and a surface contour thereon. Typically, the surface of MDF is considered generally smooth, but not completely smooth. The cured-on-substrate photopolymer 24 is provided from a powder that is ZTI9M13R2, smooth clear with filler, and is applied at a rate of 159 g/m². Melting is accomplished via hotpressing, and specifically at a temperature of 120° C. for 60 seconds. Pressure from the hotpressing is 120 N/cm². Such melting and/or pressure causes the photopolymer 24 to extend into the surface contour of the planar extend of the substrate. A release paper is used in conjunction with the use of the hotpressing. A short time period (e.g., 35 seconds) was permitted after the hotpressing. Subsequent to the short time period, the release paper is removed. Thereafter, the photopolymer is cured in place (i.e., in situ) with ultraviolet (UV) light irradiation. The time of UV light irradiation is a few seconds.

The result provides an outer surface, which is located away from the substrate 22, defined by the pressure force application. The photopolymer 24 is solidified into a cured unitary mass from application of curing irradiation. The photopolymer 24 thickness is 120 μm. A good adhesion between the photopolymer 24 and the substrate 22 is present. Also, the photopolymer has good methyl ethyl ketone (MEK) resistance. A smooth outer surface can be achieved (e.g., if the hotpressing surface is itself smooth).

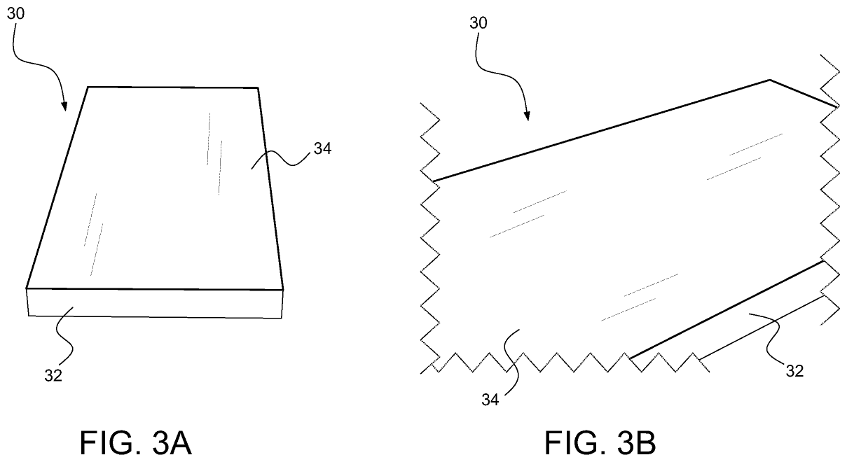

Within FIGS. 3A and 3B, an example flat panel 30 includes a substrate 32 and a cured-on-substrate photopolymer 34 thereon. Within the example, the substrate 32 is substrate therein is medium density fiberboard (MDF) with a thickness of 19 mm. As can be appreciated, the MDF substrate 32 has a planar extent and a surface contour thereon. Typically, the surface of MDF is considered generally smooth, but not completely smooth. The cured-on-substrate photopolymer 34 is provided from a powder that is ZTI9M13R2, smooth clear with filler, and is applied at a rate of 95 g/m². Melting is accomplished via hotpressing, and specifically at a temperature of 130° C. for 30 seconds. Pressure from the hotpressing is 120 N/cm². Such melting and/or pressure causes the photopolymer 34 to extend into the surface contour of the planar extend of the substrate 32. A release paper is used in conjunction with the use of the hotpressing. A short time period (e.g., 45 seconds) was permitted after the hotpressing. Subsequent to the short time period, the release paper is removed. Thereafter, the photopolymer 34 is cured in place (i.e., in situ) with ultraviolet (UV) light irradiation. The time of UV light irradiation is a few seconds.

The result provides an outer surface, which is located away from the substrate, defined by the pressure force application. The photopolymer 34 is solidified into a cured unitary mass from application of curing irradiation. The photopolymer 34 thickness is 50 μm. A good adhesion between the photopolymer 34 and the substrate 32 is present. Also, the photopolymer 34 has good methyl ethyl ketone (MEK) resistance. A smooth outer surface can be achieved (e.g., if the hotpressing surface is itself smooth).

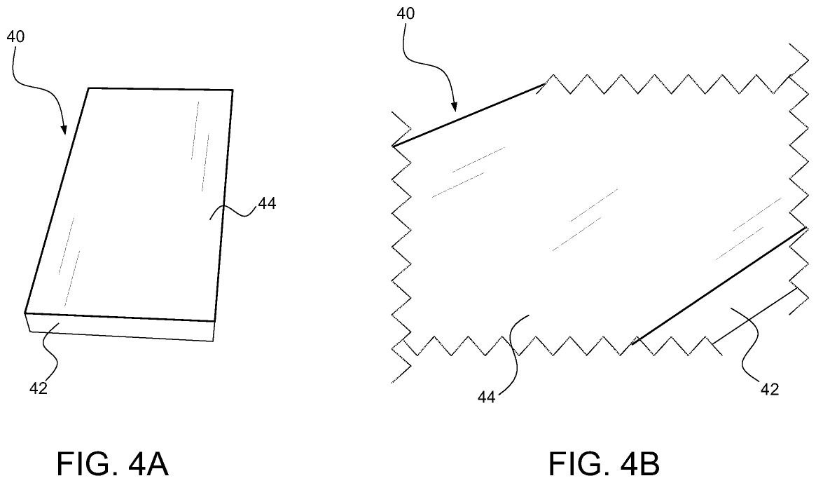

Within FIGS. 4A and 4B, an example flat panel 40 includes a substrate 42 and a cured-on-substrate photopolymer 44 thereon. Within the example, the substrate 42 is substrate therein is medium density fiberboard (MDF) with a thickness of 19 mm. As can be appreciated, the MDF substrate 42 has a planar extent and a surface contour thereon. Typically, the surface of MDF is considered generally smooth, but not completely smooth. A cured-on-substrate photopolymer 44 is provided from a powder that is ZTI9M13R5, smooth clear with filler, and is applied at a rate of 110 g/m². Melting is accomplished via hotpressing, and specifically at a temperature of 130° C. for 30 seconds. Pressure from the hotpressing is 120 N/cm². Such melting and/or pressure causes the photopolymer 44 to extend into the surface contour of the planar extend of the substrate 42. A release paper is used in conjunction with the use of the hotpressing. A short time period (e.g., 45 seconds) was permitted after the hotpressing. Subsequent to the short time period, the release paper is removed. Thereafter, the photopolymer 44 is cured in place (i.e., in situ) with ultraviolet (UV) light irradiation. The time of UV light irradiation is a few seconds.

The result provides an outer surface, which is located away from the substrate 42, defined by the pressure force application. The photopolymer 44 is solidified into a cured unitary mass from application of curing irradiation. The photopolymer thickness is 70 μm. A good adhesion between the photopolymer 44 and the substrate 42 is present. Also, the photopolymer 44 has good methyl ethyl ketone (MEK) resistance. A smooth outer surface can be achieved (e.g., if the hotpressing surface is itself smooth).

It is to be appreciated that some of the specifics can be varied and thus need not be specific limitation(s) upon the present disclosure. The present disclosure is to be broadly interpreted. For example, various/different substrates are possible and contemplated. Some examples of substrate include: a wood-including substrate, plywood, oriented strand board, particle board, medium density fiber board, wood veneer panel, fiberglass-including substrate, composite material, plastic-including substrate, sheet molded compound, bulk molded compound, and metal. Of course, other example substrates are possible, contemplated and included within the scope of this disclosure. As such, all of the examples are to be considered to be/represent such variety of substrates.

As another example of variation(s), the photopolymer can be varied. For example, different cure-type photopolymers can be utilized. For example, ultraviolet light cured photopolymer, electron beam cured photopolymer and other such irradiation-cured photopolymers are possible, contemplated and included within the scope of this disclosure. Also, as can be appreciated, the deposition rate/amount of the photopolymer upon the substrate can be varied. A few examples variations are shown in conjunction with FIGS. 1A and 1B, 2A and 2B, 3A and 3B, and 4A and 4B. Of course, the deposition rate/amount of the photopolymer is part a variation of thickness of the cured photopolymer upon the substrate. Many different rates/amounts and thicknesses are possible, contemplated and included within the scope of this disclosure. Also, the specifics of the initial powder can be varied and such variations are possible, contemplated and included within the scope of this disclosure. For example, particle size of the initial powder form of the photopolymer can be varied and such variations are possible, contemplated and included within the scope of this disclosure. Within an example, the particle size of the initial powder is in the range of 5-90 μm. As an example, a particle size of approximately 27 μm may be used.

Still other variations are possible, contemplated and included within the scope of this disclosure. For example, the outer surface of the photopolymer could be smooth or have a specific texture, contour, pattern or the like. Overall, the pressure fuses or bonds the applied and melted coating the surface of the substrate and provides certain surface characteristics (smoothness, gloss, etc.). Also, the photopolymer may have a color, be clear, be opaque, be translucent, contain additives (e.g., decorative or protective additives), etc. Coloration may be any color, combination of colors, decorative pattern, etc. so, the appearance of the photopolymer can be varied. Such variations are possible, contemplated and included within the scope of this disclosure.

Of course, it is to be appreciated that the various sizes of the panel(s), uses of the panel(s), orientations (e.g., horizontal, vertical, inclined, etc.) during use of panel(s) are contemplated and within the scope of the present invention.

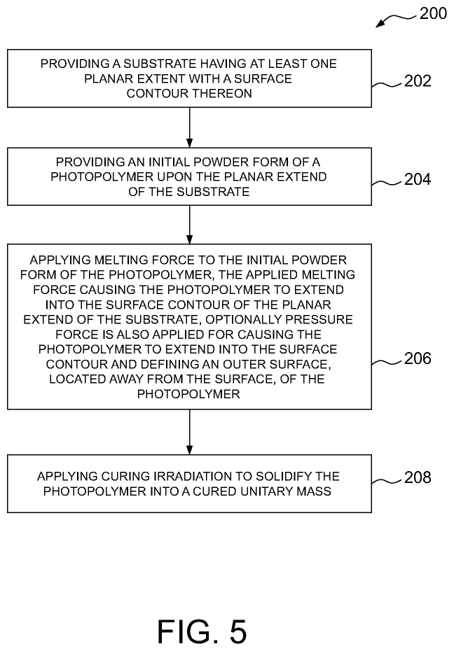

Turning to FIG. 5, a flowchart for an example method 200 for providing a flat panel in accordance with an aspect of the present disclosure is provided. At step 202 the method 200 includes providing a substrate having at least one planar extent with a surface contour thereon. At step 204, the method 200 includes providing an initial powder form of a photopolymer (e.g., photopolymer powder paint) upon the planar extend of the substrate. At step 206, the method 200 includes applying at least melting force to the initial powder form of the photopolymer. The applied melting force causing the photopolymer to extend into the surface contour of the planar extend of the substrate. Optionally, pressure force is also applied. The applied pressure force also causing the photopolymer to extend into the surface contour of the planar extend of the substrate. The pressure force application defining an outer surface the photopolymer that is located away from the substrate. At step 208, the method 200 includes applying curing irradiation to solidify the photopolymer into a cured unitary mass.

Of course, method variations, details, refinements, etc. are possible, contemplated and included within the scope of this disclosure. As some initial examples, the variations of the flat panel in accordance with the present disclosure can be attendant with method variations, details, refinements, etc.

As an example, the step 202 of the method 200 can have variations, details, refinements, etc. For example, the step 202 can include providing the substrate to include: a wood-including substrate, plywood, oriented strand board, particle board, medium density fiber board, wood veneer panel, fiberglass-including substrate, carbon fiber including material, composite material, plastic-including substrate, sheet molded compound, bulk molded compound, and metal (ferrous or non-ferrous metal). Of course, other example substrates for step 202 are possible, contemplated and included within the scope of this disclosure.

As another example, the step 204 of the method 200 can have variations, details, refinements, etc. For example, the step 204 can include providing various/different cure-type photopolymers, such as an ultraviolet light cured photopolymer, an electron beam cured photopolymer and other such irradiation-cured photopolymers. Application can be by powder scattering or electrostatic deposition. As another example, particle size of the initial powder form of the photopolymer can be varied and such variations are possible, contemplated and included within the scope of this disclosure. Within an example, the particle size of the initial powder is in the range of 5-90 μm. As another example, the step 204 can include a variety of the deposition rates/amounts of the photopolymer upon the substrate. A few examples variations are shown in conjunction with FIGS. 1A and 1B, 2A and 2B, 3A and 3B, and 4A and 4B.

As another example, the step 206 of the method 200 can have variations, details, refinements, etc. For example, the step 206 can include providing various/different types of applying melting and pressure forces to the initial powder form of the photopolymer. It is to be noted that step 206 can provide for applying melting and pressure forces simultaneously, sequentially, step-wise, etc. As some examples regarding melting, the step can include applying heat, applying thermal heat energy, applying induction heating, applying convection heating, applying infrared energy, applying near infrared energy, applying a gas catalytic infrared energy, etc. Also, as some examples, step 206 can include includes transitioning the photopolymer at least one of a liquid and gel state. As some examples, the range of temperature is 90° C. to 200° C. The time associated with melting can include one or more aspects/functions, such as speed of movement of the substrate, coating thickness, coating chemistry, etc. As some additional examples regarding pressure, the application of pressure at step 206 can include the use of a platen press, a roller, a roller press, a continuous feed roller press, etc. The applied melting and pressure forces causing the photopolymer to extend into the surface contour of the planar extend of the substrate. The pressure force application defining an outer surface the photopolymer that is located away from the substrate. Pressure fuses or bonds the applied and melted coating the surface of the substrate and provides certain surface characteristics (smoothness, gloss and others).

Variations to the resulting panel resulting from the variations step 206 are possible. For example, variations of the extent of the photopolymer into the substrate as caused by the applied melting and pressure forces are possible, contemplated and included within the scope of this disclosure. As another example, variations of outer surface (e.g., smooth, textured, etc.) the photopolymer as caused by the applied melting and pressure forces are possible, contemplated and included within the scope of this disclosure. Of course, other example variations for step 206 are possible, contemplated and included within the scope of this disclosure.

As another example, the step 208 of the method 200 can have variations, details, refinements, etc. For example, the step 208 can include applying ultraviolet energy or applying electron beam energy. The time associated with applying curing irradiation can include one or more aspects/functions, such as speed of movement of the substrate, coating thickness, coating chemistry, etc. Of course, other example variations for step 208 are possible, contemplated and included within the scope of this disclosure.

So, as some general recap for some of the examples, the application of powder (e.g., powder paint) is coated onto a two-dimensional panel. Such may be within a horizontal continuous conveyor. Panel size and feed rate are indeterminate and based upon specifications outside the purview of this description. The panel moves forward and passes through the powder application system. Application of the powder can be by powder scattering or electrostatic deposition. Following powder application, the deposited coating is melted to a gelled state. The range of temperature is 90° C. to 200° C. The time to melt can be a function of speed, coating thickness and coating chemistry. After the coating has reached the desired melting temperature pressure is applied by either a static platen press or roller(s). Pressure fuses or bonds the applied and melted coating the surface of the substrate and provides certain surface characteristics (smoothness, gloss and others). Once the desired bonding and surface conditions are reached the coating is cured using either thermal energy, UV or EB energy sources. Cure conditions are dependent upon the type of curing system.

It is to be appreciated that the method, and variants thereof, disclosed with the present disclosure are for making the flat panel, and variants thereof, mentioned within the present disclosure. As such, it is to be appreciated that the discussions regarding the flat panel are incorporated hereat, with an understanding that the method, and variants thereof, can include steps to make the flat panel, and variants thereof, mentioned within the present disclosure. Such method/steps are possible, contemplated and included within the scope of this disclosure.

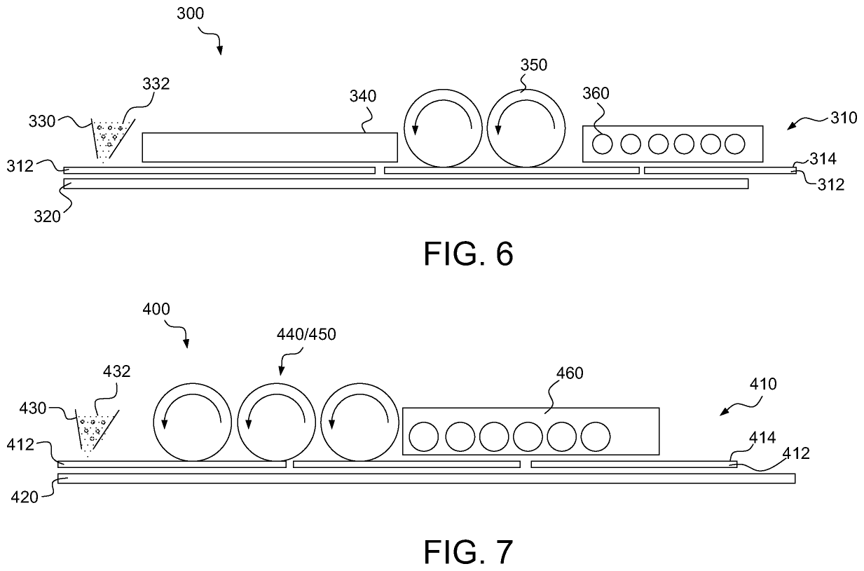

Turning now to FIG. 6, a very schematic illustration of an apparatus 300 performing a method for making a flat panel 310 in accordance with the present disclosure is shown. The panel 310 which is made has a substrate 312 with at least one planar extent with a surface contour thereon, and a cured-on-substrate photopolymer 314 upon the planar extend of the substrate. The photopolymer 314 extends into the surface contour of the planar extend of the substrate 312 from application of at least melting force to an initial powder form of the photopolymer. Within the shown example of FIG. 6, pressure force is also applied. The photopolymer has an outer surface, located away from the substrate, defined by the pressure force application. The photopolymer is solidified into a cured unitary mass from application of curing irradiation.

It is to be appreciated that the width of the substrate 312, and thus the finished panel 310, may have any of a variety of widths. The width is subject to the width of the apparatus 300. The height of the substrate 312 may be varied. As an example, a height of approximately 0.75 inch or greater or lesser may be used. Additional width, as provided by the photopolymer 314, may be varied and may be dependent upon amount provided. The length of the substrate 312 is along the process direction of the apparatus 300 as discussed following. The length of the substrate 312, and thus the finished panel 310, may be any length and thus is somewhat indeterminant. Within an example the length of the substrate 312 is any length that is useful for the finished panel 310.

Within the example of FIG. 6, the apparatus 300 includes an arrangement 320 for receiving the substrate 312. Within the shown example, the substrate 312 is received upon a continuous conveyor type arrangement 320. The conveyor arrangement moves the substrate/panel in a horizontal direction (e.g., from left to right in FIG. 6). It is to be appreciated that such arrangement 320 for receiving the substrate 312 may have a variety of constructions/configurations. Such variety of constructions/configurations are possible, contemplated and included within the scope of this disclosure.

Within the example of FIG. 6, the apparatus 300 includes an arrangement 330 for applying the initial powder 332 form of the photopolymer 314 onto the planar extend of the substrate 312. As shown in FIG. 6, such arrangement 330 is schematically represented by a showing of particles proceeding downwardly toward the conveyor 320, and the substrate 312 that is moved via the conveyor. It is to be appreciated that such arrangement 330 for applying the initial powder form 332 of the photopolymer 314 onto the planar extend of the substrate 312 may have a variety of constructions/configurations. Such variety of constructions/configurations are possible, contemplated and included within the scope of this disclosure.

Within the example of FIG. 6, the apparatus 300 includes an arrangement 340 for applying the melting force. As shown in FIG. 6, such arrangement 340 is schematically represented by an area and can provide any of several melt-providing options. The arrangement 340 may include infrared (IR) elements, near IR elements, convention heating, conduction heating, or the like. It is to be appreciated that such arrangement 340 for applying the melting force may have a variety of constructions/configurations. Such variety of constructions/configurations are possible, contemplated and included within the scope of this disclosure.

Within the example of FIG. 6, the apparatus 300 includes an arrangement 350 for applying the pressure force. As shown in FIG. 6, such arrangement 350 is schematically represented by example rollers 350. It is to be appreciated that such arrangement 350 for applying the pressure force may have a variety of constructions/configurations. Such variety of constructions/configurations are possible, contemplated and included within the scope of this disclosure.

The arrangements 340 and 350 for applying the melting and pressure forces are configured such that the initial powder form 332 of the photopolymer extends into the surface contour of the planar extend of the substrate 312 and the photopolymer has a defined outer surface located away from the substrate.

Within the example of FIG. 6, the apparatus 300 includes an arrangement 360 for applying the curing irradiation to the photopolymer. As shown in FIG. 6, such is schematically represented by an area to apply any of several irradiation-providing options. Within an example, the arrangement 360 includes ultraviolet lights, electron beam emitters, or the like. The specific curing irradiation may be selected based upon the particulars of the photopolymer. It is to be appreciated that such arrangement 360 for applying the curing irradiation may have a variety of constructions/configurations. Such variety of constructions/configurations are possible, contemplated and included within the scope of this disclosure.

Within an example the substrate 312 may be loaded onto the continuous conveyor 320 that is moving at a speed that is greater than zero. Within an example the speed is approximately 150 feet per minute. Various factors may be considered to choose a speed of operation. Some factors include rate of powder deposition by the arrangement 330 for applying the initial powder form 332, area available for conveyor length, a balance of capacity with demand, the type of the arrangement 350 for applying the pressure force (e.g., pressing system, time under press roller and pressure, etc.), and cure profile of the photopolymer.

Within an example, the powder deposition (e.g., application) by the arrangement 330 for applying the initial powder 332 may be varied. Specific selection of such variation may be in consideration of type and factors. For example, powder scattering may be used. As another example, corona or tribo electrostatic distribution of the powder may be used.

Within an example, the powder melting by the arrangement 340 for applying the melting force can be varied and be by various methods. Within an example, the melting is via provision of sufficient heat to melt the powder within a target range of approximately 110° C. to 130° C. Some examples of types of provision of heat force include IR, Convection, Hybrid IR/convection, NIR or other.

Within an example, the provision of pressure by the arrangement 350 for applying the pressure force may be varied and be by various methods. Within an example, which is schematically shown in FIG. 6, the pressing is with roller(s). Such may provide for the functions to fuse and smooth the powder. It is to be appreciated that applying the pressure force may be associated with the resulting surface being smooth or having a texture. Such may dependent upon the smoothness or texture of the roller(s) (e.g., as a transfer from the roller). In addition or alternatively, texture may come from the chemistry of the powder.

Within an example, aspect of the arrangement 350 may be varied. For example, the arrangement 350 (e.g., the roller(s)) for applying the pressure force may be unheated or heated or even cooled. Also, the material(s) of the arrangement 350 (e.g., the roller(s)) for applying the pressure force may be varied/selected. As some examples, roller material may be steel or coated or another. Still further the number of parts/portions of the arrangement 350 (e.g., the roller(s)) for applying the pressure force may be varied/selected. As an example, the number of rollers may be selected. It is contemplated that the number may be a function of line speed and/or time under pressure to achieve desired finished characteristic.

Within an example, the arrangement 360 for applying the curing irradiation to the photopolymer may be varied and be by various methods. As some examples, curing can be by various high energy sources. Some examples of energy/energy sources include: medium pressure mercury lamps, pulsed xenon lamps, LEDs or, Electron beam (EB), and other types of high energy sources such as laser.

It is to be appreciated that the finished panels 310 are off loaded from the apparatus 300 for storage, packaging, shipment, etc. Such offloading may be in any of several formats including manual, automatic, etc.

Turning now to FIG. 7, a very schematic illustration of an apparatus 400 performing a method for making a flat panel 410 in accordance with the present disclosure is shown. The panel 410 which is made has a substrate 412 with at least one planar extent with a surface contour thereon, and a cured-on-substrate photopolymer 414 upon the planar extend of the substrate. The photopolymer 414 extends into the surface contour of the planar extend of the substrate 412 from application of at least melting force to an initial powder form of the photopolymer. Within the shown example of FIG. 7, pressure force is also applied. The photopolymer has an outer surface, located away from the substrate, defined by the pressure force application. The photopolymer is solidified into a cured unitary mass from application of curing irradiation.

It is to be appreciated that the width of the substrate 412, and thus the finished panel 410, may have any of a variety of widths. The width is subject to the width of the apparatus 400. The height of the substrate 412 may be varied. As an example, a height of approximately 0.75 inch or greater or lesser may be used. Additional width, as provided by the photopolymer 414, may be varied and may be dependent upon amount provided. The length of the substrate 412 is along the process direction of the apparatus 300 as discussed following. The length of the substrate 412, and thus the finished panel 410, may be any length and thus is somewhat indeterminant. Within an example the length of the substrate 412 is any length that is useful for the finished panel 410.

Within the example of FIG. 7, the apparatus 400 includes an arrangement 420 for receiving the substrate 412. Within the shown example, the substrate 412 is received upon a continuous conveyor type arrangement 420. The conveyor arrangement moves the substrate/panel in a horizontal direction (e.g., from left to right in FIG. 7). It is to be appreciated that such arrangement 420 for receiving the substrate 412 may have a variety of constructions/configurations. Such variety of constructions/configurations are possible, contemplated and included within the scope of this disclosure.

Within the example of FIG. 7 the apparatus 400 includes an arrangement 330 for applying the initial powder 332 form of the photopolymer 414 onto the planar extend of the substrate 412. As shown in FIG. 7, such arrangement 430 is schematically represented by a showing of particles proceeding downwardly toward the conveyor 420, and the substrate 412 that is moved via the conveyor. It is to be appreciated that such arrangement 430 for applying the initial powder form 432 of the photopolymer 414 onto the planar extend of the substrate 412 may have a variety of constructions/configurations. Such variety of constructions/configurations are possible, contemplated and included within the scope of this disclosure.

Within the example of FIG. 7, the apparatus 400 includes a combined arrangement 440/450 for applying the melting and pressure forces. As shown in FIG. 7, combined arrangement 440/450 is schematically represented by example rollers and the roller are heated. The heating may be via various means such as heating elements, circulation of heated fluid, or the like. It is to be appreciated that such arrangement 440/450 for applying the melting and pressure forces may have a variety of constructions/configurations. Such variety of constructions/configurations are possible, contemplated and included within the scope of this disclosure. The arrangement 440/450 for applying the melting and pressure forces is configured such that the initial powder form 432 of the photopolymer extends into the surface contour of the planar extend of the substrate 412 and the photopolymer has a defined outer surface located away from the substrate.

Within the example of FIG. 7, the apparatus 400 includes an arrangement 460 for applying the curing irradiation to the photopolymer. As shown in FIG. 7, such is schematically represented by an area to apply any of several irradiation-providing options. Within an example, the arrangement 460 includes ultraviolet lights, electron beam emitters, or the like. The specific curing irradiation may be selected based upon the particulars of the photopolymer. It is to be appreciated that such arrangement 460 for applying the curing irradiation may have a variety of constructions/configurations. Such variety of constructions/configurations are possible, contemplated and included within the scope of this disclosure.

Within an example the substrate 412 may be loaded onto the continuous conveyor 420 that is moving at a speed that is greater than zero. Within an example the speed is approximately 150 feet per minute. Various factors may be considered to choose a speed of operation. Some factors include rate of powder deposition by the arrangement 330 for applying the initial powder form 432, area available for conveyor length, a balance of capacity with demand, the type of the arrangement 440/450 for applying the melting and pressure forces (e.g., time under press roller and pressure, time needed to heat such as to a target range of approximately 110° C. to 130° C., etc.), and cure profile of the photopolymer.

Within an example, the powder deposition (e.g., application) by the arrangement 430 for applying the initial powder 432 may be varied. Specific selection of such variation may be in consideration of type and factors. For example, powder scattering may be used. As another example, corona or tribo electrostatic distribution of the powder may be used.

Within an example, the provision of pressure by the arrangement 440/450 for applying the melting and pressure forces may be varied and be by various methods. Within an example, which is schematically shown in FIG. 7, the pressing is with roller(s). Such may provide for the functions to fuse and smooth the powder. It is to be appreciated that applying the pressure force may be associated with the resulting surface being smooth or having a texture. Such may dependent upon the smoothness or texture of the roller(s) (e.g., as a transfer from the roller). In addition or alternatively, texture may come from the chemistry of the powder. Also, the material(s) of the arrangement 440/450 (e.g., the roller(s)) for applying the melting and pressure forces may be varied/selected. As some examples, roller material may be steel or coated or another. Still further the number of parts/portions of the arrangement 440/450 (e.g., the roller(s)) for applying the pressure force may be varied/selected. As an example, the number of rollers may be selected. It is contemplated that the number may be a function of line speed and/or time under pressure to achieve desired finished characteristic.

Within an example, the arrangement 460 for applying the curing irradiation to the photopolymer may be varied and be by various methods. As some examples, curing can be by various high energy sources. Some examples of energy/energy sources include: medium pressure mercury lamps, pulsed xenon lamps, LEDs or Electron beam (EB), and other types of high energy sources such as laser.

It is to be appreciated that the finished panels 410 are off loaded from the apparatus 400 for storage, packaging, shipment, etc. Such offloading may be in any of several formats including manual, automatic, etc.

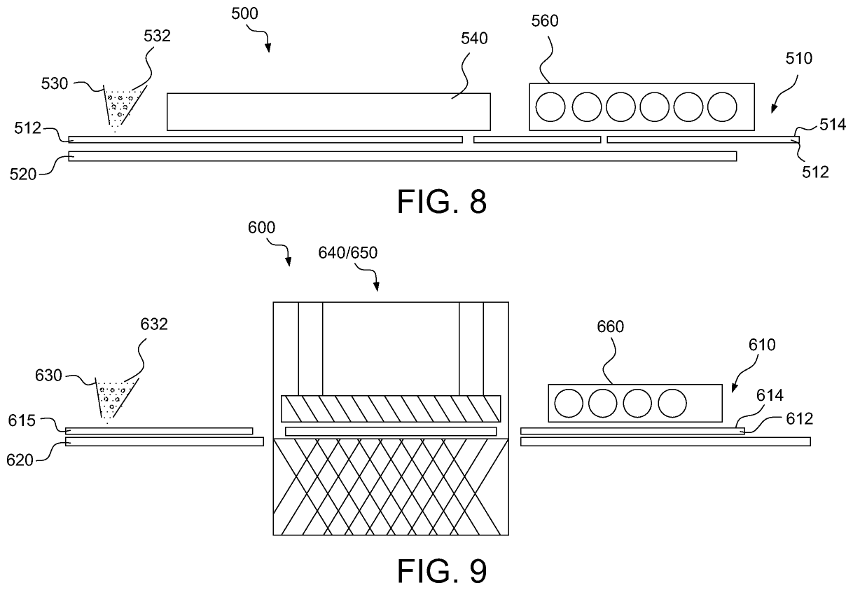

Turning now to FIG. 8, a very schematic illustration of an apparatus 500 performing a method for making a flat panel 510 in accordance with the present disclosure is shown. The panel 510 which is made has a substrate 512 with at least one planar extent with a surface contour thereon, and a cured-on-substrate photopolymer 514 upon the planar extend of the substrate. The photopolymer 514 extends into the surface contour of the planar extend of the substrate 512 from application of at least melting force to an initial powder form of the photopolymer. Within the shown example of FIG. 8, pressure force is also applied. The photopolymer has an outer surface, located away from the substrate, defined by the pressure force application. The photopolymer is solidified into a cured unitary mass from application of curing irradiation.

It is to be appreciated that the width of the substrate 512, and thus the finished panel 510, may have any of a variety of widths. The width is subject to the width of the apparatus 500. The height of the substrate 512 may be varied. As an example, a height of approximately 0.75 inch or greater or lesser may be used. Additional width, as provided by the photopolymer 514, may be varied and may be dependent upon amount provided. The length of the substrate 512 is along the process direction of the apparatus 300 as discussed following. The length of the substrate 512, and thus the finished panel 510, may be any length and thus is somewhat indeterminant. Within an example the length of the substrate 512 is any length that is useful for the finished panel 410.

Within the example of FIG. 8, the apparatus 500 includes an arrangement 520 for receiving the substrate 512. Within the shown example, the substrate 512 is received upon a continuous conveyor type arrangement 520. The conveyor arrangement moves the substrate/panel in a horizontal direction (e.g., from left to right in FIG. 8). It is to be appreciated that such arrangement 520 for receiving the substrate 512 may have a variety of constructions/configurations. Such variety of constructions/configurations are possible, contemplated and included within the scope of this disclosure.

Within the example of FIG. 8 the apparatus 500 includes an arrangement 530 for applying the initial powder 532 form of the photopolymer 514 onto the planar extend of the substrate 512. As shown in FIG. 8, such arrangement 530 is schematically represented by a showing of particles proceeding downwardly toward the conveyor 520, and the substrate 512 that is moved via the conveyor. It is to be appreciated that such arrangement 530 for applying the initial powder form 532 of the photopolymer 514 onto the planar extend of the substrate 512 may have a variety of constructions/configurations. Such variety of constructions/configurations are possible, contemplated and included within the scope of this disclosure.

Within the example of FIG. 8, the apparatus 500 includes an arrangement 540 for applying the melting force. As shown in FIG. 8, such arrangement 540 is schematically represented by an area and can provide any of several melt-providing options. The arrangement 540 may include infrared (IR) elements, near IR elements, convection heating, conduction heating, induction heating, or the like. It is to be appreciated that such arrangement 540 for applying the melting force may have a variety of constructions/configurations. Such variety of constructions/configurations are possible, contemplated and included within the scope of this disclosure.

Within the example of FIG. 8, it is to be noted that the example apparatus 300 does not includes an arrangement for applying the pressure force. For the example of FIG. 8, the arrangement 540 for applying the melting force is configured such that the initial powder form 532 of the photopolymer extends (e.g., via melt flow) into the surface contour of the planar extend of the substrate 512 and the photopolymer has a defined outer surface located away from the substrate.

Within the example of FIG. 8, the apparatus 500 includes an arrangement 560 for applying the curing irradiation to the photopolymer. As shown in FIG. 8, such is schematically represented by an area to apply any of several irradiation-providing options. Within an example, the arrangement 560 includes ultraviolet lights, electron beam emitters, or the like. The specific curing irradiation may be selected based upon the particulars of the photopolymer. It is to be appreciated that such arrangement 560 for applying the curing irradiation may have a variety of constructions/configurations. Such variety of constructions/configurations are possible, contemplated and included within the scope of this disclosure.

Within an example the substrate 512 may be loaded onto the continuous conveyor 520 that is moving at a speed that is greater than zero. Within an example the speed is approximately 150 feet per minute. Various factors may be considered to choose a speed of operation. Some factors include rate of powder deposition by the arrangement 530 for applying the initial powder form 532, area available for conveyor length, a balance of capacity with demand, and cure profile of the photopolymer.

Within an example, the powder deposition (e.g., application) by the arrangement 530 for applying the initial powder 532 may be varied. Specific selection of such variation may be in consideration of type and factors. For example, powder scattering may be used. As another example, corona or tribo electrostatic distribution of the powder may be used.

Within an example, the powder melting by the arrangement 540 for applying the melting force can be varied and be by various methods. Within an example, the melting is via provision of sufficient heat to melt the powder within a target range of approximately 110° C. to 130° C. Some examples of types of provision of heat force include IR, Convection, Hybrid IR/convection, NIR or other. It is to be appreciated that applying the melting force may be associated with the resulting surface being smooth or having a texture. In addition or alternatively, texture may come from the chemistry of the powder.

Within an example, the arrangement 560 for applying the curing irradiation to the photopolymer may be varied and be by various methods. As some examples, curing can be by various high energy sources. Some examples of energy/energy sources include: medium pressure mercury lamps, pulsed xenon lamps, LEDs or Electron beam (EB), and other types of high energy sources such as laser.

It is to be appreciated that the finished panels 510 are off loaded from the apparatus 500 for storage, packaging, shipment, etc. Such offloading may be in any of several formats including manual, automatic, etc.

It is to be appreciated that use of a continuous conveyor is simply one type of device/structure for receiving the substrate and performing a method to provide finished panels. The present disclosure is not limited to use of continuous conveyor and other devices/structures are contemplated and within the scope of the present disclosure. For example, the process may be an interval process. As an example, attention is directed to FIG. 9.

Within FIG. 9, a very schematic illustration of an apparatus 600 performing a method for making a flat panel 610 in accordance with the present disclosure is shown. The panel 610 which is made has a substrate 612 with at least one planar extent with a surface contour thereon, and a cured-on-substrate photopolymer 614 upon the planar extend of the substrate. The photopolymer 614 extends into the surface contour of the planar extend of the substrate 612 from application of at least melting force to an initial powder form of the photopolymer. Within the shown example of FIG. 9, pressure force is also applied. The photopolymer has an outer surface, located away from the substrate, defined by the pressure force application. The photopolymer is solidified into a cured unitary mass from application of curing irradiation.

It is to be appreciated that the width of the substrate 612, and thus the finished panel 610, may have any of a variety of widths. The width is subject to the width of the apparatus 600. The height of the substrate 612 may be varied. As an example, a height of approximately 0.75 inch or greater or lesser may be used. Additional width, as provided by the photopolymer 614, may be varied and may be dependent upon amount provided. The length of the substrate 612 is along the process direction of the apparatus 300 as discussed following. The length of the substrate 612, and thus the finished panel 610, may be any length and thus is somewhat indeterminant. Within an example the length of the substrate 612 is any length that is useful for the finished panel 410.

Within the example of FIG. 9, the apparatus 600 includes an arrangement 620 for receiving the substrate 612. Within the shown example, the substrate 612 is received upon am intermittent movement arrangement 620. The arrangement 620 has a series of work station or locations. Intermittent movement of the substrate/panel in a horizontal direction (e.g., from left to right in FIG. 7) among the different work station or locations. It is to be appreciated that such arrangement 620 for receiving the substrate 612 may have a variety of constructions/configurations. For example, the work station or locations may be specific to the operation(s)/function(s) performed thereat. Such variety of constructions/configurations are possible, contemplated and included within the scope of this disclosure.

Within the example of FIG. 9 the apparatus 600 includes an arrangement 630 for applying the initial powder 632 form of the photopolymer 614 onto the planar extend of the substrate 612. As shown in FIG. 9, such arrangement 630 is schematically represented by a showing of particles proceeding downwardly toward the substrate 412. It is to be appreciated that such arrangement 630 for applying the initial powder form 632 of the photopolymer 614 onto the planar extend of the substrate 612 may have a variety of constructions/configurations. Such variety of constructions/configurations are possible, contemplated and included within the scope of this disclosure.

Within the example of FIG. 9, the apparatus 600 includes a combined arrangement 640/650 for applying the melting and pressure forces. As shown in FIG. 9, combined arrangement 640/650 is schematically represented by a platen press. Moreover, the example platen press is heated. It is to be appreciated that such arrangement 640/650 for applying the melting and pressure forces may have a variety of constructions/configurations. Such variety of constructions/configurations are possible, contemplated and included within the scope of this disclosure. The arrangement 640/650 for applying the melting and pressure forces is configured such that the initial powder form 632 of the photopolymer extends into the surface contour of the planar extend of the substrate 612 and the photopolymer has a defined outer surface located away from the substrate.

Within the example of FIG. 7, the apparatus 600 includes an arrangement 660 for applying the curing irradiation to the photopolymer. As shown in FIG. 9, such is schematically represented by an area to apply any of several irradiation-providing options. Within an example, the arrangement 660 includes ultraviolet lights, electron beam emitters, or the like. The specific curing irradiation may be selected based upon the particulars of the photopolymer. It is to be appreciated that such arrangement 660 for applying the curing irradiation may have a variety of constructions/configurations. Such variety of constructions/configurations are possible, contemplated and included within the scope of this disclosure.

Within an example, the powder deposition (e.g., application) by the arrangement 630 for applying the initial powder 632 may be varied. Specific selection of such variation may be in consideration of type and factors. For example, powder scattering may be used. As another example, corona or tribo electrostatic distribution of the powder may be used.

Within an example, the provision of pressure by the arrangement 640/650 for applying the melting and pressure forces may be varied and be by various methods. Within an example, it is to be appreciated that applying the pressure force may be associated with the resulting surface being smooth or having a texture. Such may dependent upon the smoothness or texture of the press face of the press (e.g., as a transfer from the press). In addition or alternatively, texture may come from the chemistry of the powder. Also, the material(s) of the arrangement 640/650 (e.g., the press face) for applying the melting and pressure forces may be varied/selected. As some examples, the material may be steel or coated or another. Still further the number of parts/portions of the arrangement 640/650 for applying the pressure force may be varied/selected.

Within an example, the arrangement 660 for applying the curing irradiation to the photopolymer may be varied and be by various methods. As some examples, curing can be by various high energy sources. Some examples of energy/energy sources include: medium pressure mercury lamps, pulsed xenon lamps, LEDs or Electron beam (EB), and other types of high energy sources such as laser.

It is to be appreciated that the finished panels 610 are off loaded from the apparatus 600 for storage, packaging, shipment, etc. Such offloading may be in any of several formats including manual, automatic, etc.

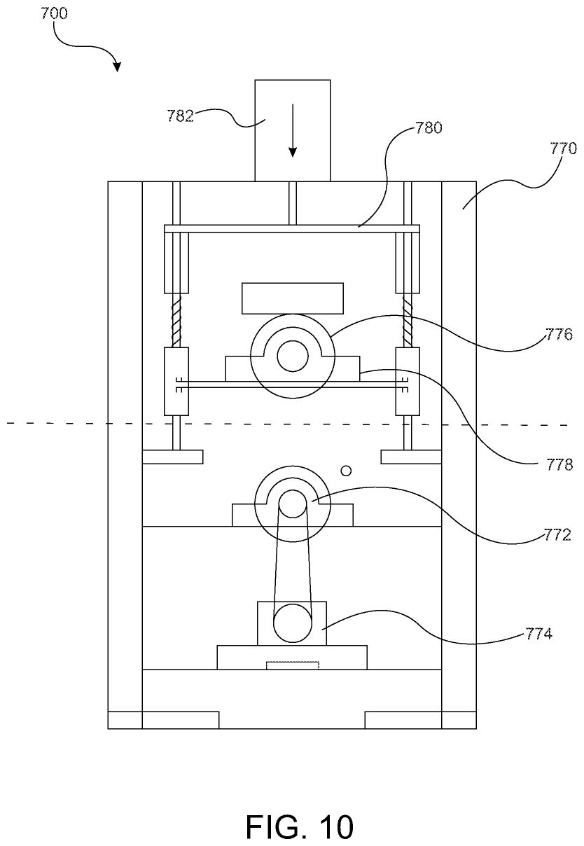

Turning now to FIG. 10, a very schematic illustration is a representation 700 of the arrangements 340 and combined arrangements 440/450 and 640/650. To be sure the schematic illustration of FIG. 10 need not be a specific limitation upon the present disclosure and any of the previously discussed examples. FIG. 10 is merely to illustrate examples aspects of application of pressure and/or melting forces.

Within the example of FIG. 10, there is a main frame 770 for floor support. Ultimately, all other arrangements of the apparatus, and the components for making a panel are supported/received/connected/paired therein/thereon. Within the example, a bottom drive roller 772 with a gear motor 774 is provided. Such bottom drive roller 772 with a gear motor can be part of supporting and moving the panels during the method of making.

Within the example, a top roller (e.g., a 6-inch roller) 776 with an infrared heater and preheat cycle drive 778 is provided. Such can be part of an arrangement for applying melt and pressure forces. Within the example, a vertical press slide 780 for thickness compensation is provided. Such can be part of the arrangement for applying pressure forces and to provide for adjustment to accommodate thickness variation of the panel. Within the example, a pneumatic cylinder 782 with regulator is provided. Such can be part of the arrangement for applying pressure forces and to provide for adjustment to accommodate thickness variation of the panel. Within the example, controls, within a control enclosure, with associated controller for drives, temperature, etc. are provided.

It is to be appreciated that the apparatus, and variants thereof, disclosed with the present disclosure are for making the flat panel, and variants thereof, mentioned within the present disclosure and/or performing the method, and variants thereof, mentioned within the present disclosure. As such, it is to be appreciated that the discussions regarding the flat panel and/or the method are incorporated hereat, with an understanding that the apparatus, and variants thereof, can include arrangements, portions, parts, etc. to make the flat panel, and variants thereof, mentioned within the present disclosure and/or perform the method, and variants thereof, mentioned within the present disclosure. Such apparatus, and included arrangements, portions, parts, etc., are possible, contemplated and included within the scope of this disclosure.

As a consideration of time required to manufacture a comparison between currently available techniques and the present disclosure is to be noted.

For currently available techniques that utilize a thermal-melt powder that is heated and pressed for panel lamination, the laminate is applied and held under pressure in a press for a sufficient time for the adhesion to occur. As an example of a held-in press time can be 1-10 minutes. As such, use of a platen press, e.g., a single panel press, is logical because a continuously moving arrangement (e.g., a conveyor with a pressure maintained for the entire adhesion process) would need to be very large. For example, to use conveyor process with a thermal cured powder would require an extraordinarily long conveyor system. Assuming a line speed of 100 feet/minute (approx. 91 meters/minute) and a melt to cure time of 3 minutes, the conveyor length would need to be 300 feet (approx. 91 meters) for just the pressing time and the pressing would need to occur for the 300 feet (approx. 91 meters) length.

The present disclosure UV cured powder system is significantly shorter, melt, press, and UV cured.

In contrast, the present disclosure can readily be accommodated in connection with a continuous conveyor speed in the range of 30 to 150 feet/minute (approx. 9 to 45 meters/minute) or more. Such is via the photopolymer being solidified into a cured unitary mass via the application of the curing irradiation in a relatively short time period.

As an example comparison, consider a thermocure polymer that has a 3:30 minute cycle time to melt and cure. Finishing a 4 feet by 8 feet panel yields 33 square feet. So, with a 3:30 minute cycle time for each 4 feet by 8 feet panel, the total hourly yield is 548 square feet per hour. In contrast and as an improvement, the present disclosure provide a much better hourly yield. For example, assuming a 1:30 minute cycle time to melt and UV cure, and with a 4 feet by 8 feet panel yielding 32 square feet, the total hourly yield is 1980 square feet per hour. As an example, such may occur for the example shown within FIG. 9. Now going further, additional production yields are achieved via the use of a continuous conveyor. See for example FIGS. 6-8. For a continuous conveyor, assuming a line speed of 50 feet minute the total hourly yield will be 12,000 square feet per hour.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an instance, illustration, etc., and not necessarily as advantageous. As used herein, “or” is intended to mean an inclusive “or” rather than an exclusive “or.” In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes,” “having,” “has,” “with,” and/or variants thereof are used in either the detailed description or the claims, such terms are intended to be inclusive in a manner similar to the term “comprising.”

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations are described herein should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed:

1. A flat panel comprising:
a substrate having at least one planar extent with a surface contour thereon; and
a cured-on-substrate photopolymer upon the planar extend of the substrate, the photopolymer extending into the surface contour of the planar extend of the substrate from application of a melting force to an initial powder form of the photopolymer, and the photopolymer solidified into a cured unitary mass from application of curing irradiation.

2. The panel as set forth in claim 1, wherein the photopolymer extending into the surface contour of the planar extend of the substrate being also from application of pressure force, and the photopolymer having an outer surface, located away from the substrate, defined by the pressure force application.

3. The panel as set forth in claim 1, wherein the photopolymer is an ultraviolet light cured photopolymer.

4. The panel as set forth in claim 1, wherein the photopolymer is an electron beam cured photopolymer.

5. The panel as set forth in claim 1, wherein the photopolymer is an infrared-melt photopolymer.

6. The panel as set forth in claim 1, wherein the photopolymer is a near infrared-melt photopolymer.

7. The panel as set forth in claim 1, wherein the photopolymer is a gas catalytic infrared-melt photopolymer.

8. The panel as set forth in claim 1, wherein the photopolymer is a thermal heat-melt photopolymer.

9. The panel as set forth in claim 1, wherein the substrate includes wood.

10. The panel as set forth in claim 9, wherein the substrate includes one of plywood, oriented strand board, particle board, medium density fiber board and wood veneer panel.

11. The panel as set forth in claim 1, wherein the substrate includes fiberglass.

12. The panel as set forth in claim 1, wherein the substrate includes composite material.

13. The panel as set forth in claim 1, wherein the substrate includes plastic.

14. The panel as set forth in claim 1, wherein the substrate includes a molded compound.

15. The panel set forth in claim 1, where in the substrate includes metal.

16. The panel as set forth in claim 1, wherein the initial powder form of the photopolymer has a particle size in the range of 5-90 μm.

17. The panel as set forth in claim 1, wherein the initial powder form of the photopolymer achieves at least one of a liquid and gel state by the application of the melting force.

18. A method of providing a flat panel, the method comprising:
providing a substrate having at least one planar extent with a surface contour thereon;
providing an initial powder form of a photopolymer upon the planar extend of the substrate;
applying melting force to the initial powder form of the photopolymer, the applied melting force causing the photopolymer to extend into the surface contour of the planar extend of the substrate; and
applying curing irradiation to solidify the photopolymer into a cured unitary mass.

19. The method as set forth in claim 18 further including applying pressure force to cause the photopolymer to extend into the surface contour of the planar extend of the substrate, the pressure force application defining an outer surface the photopolymer that is located away from the substrate.

20. An apparatus for making a flat panel, the panel having a substrate with at least one planar extent with a surface contour thereon, and a cured-on-substrate photopolymer upon the planar extend of the substrate, the photopolymer extending into the surface contour of the planar extend of the substrate from application of melting force to an initial powder form of the photopolymer, and the photopolymer solidified into a cured unitary mass from application of curing irradiation, the apparatus comprising:
an arrangement for receiving the substrate;
an arrangement for applying the initial powder form of the photopolymer onto the planar extend of the substrate;
an arrangement for applying the melting force; and
an arrangement for applying the curing irradiation to the photopolymer.
